(19) United States
(12) Patent Application Publication
(10) Pub. No.: US 2025/0378288 A1
(43) Pub. Date: Dec. 11, 2025

(54) APPARATUS AND METHOD FOR OPERATING AN APPARATUS

(71) Applicant: Infineon Technologies AG, Neubiberg (DE)

(72) Inventors: Josef Gruber, Sankt Ruprecht An Der Raab (AT); Edmund Ehrlich, Graz (AT); Benjamin Dorner, Graz (AT); Josef Riegebauer, Graz (AT); Walter Kargl, Graz (AT)

(21) Appl. No.: 19/233,148

(22) Filed: Jun. 10, 2025

(30) Foreign Application Priority Data
Jun. 10, 2024 (DE) 102024205331.7

(51) Int. Cl. G06K 7/10; H02M 5/04

(52) U.S. Cl. CPC G06K 7/10217; H02M 5/04

(57) ABSTRACT

An apparatus having at least one processor which is configured to: perform an operation using energy provided by an external reading device, wherein, when performing the operation, an input voltage of a near-field radio receiver is regulated to a predefined first input voltage value; and, after the operation has been completed, while the near-field radio receiver is still in the electromagnetic field generated by the external reading device, regulate the input voltage of the near-field radio receiver to a second input voltage value lower than the first input voltage value.

### TECHNICAL FIELD

The disclosure relates to an apparatus and a method.

### BACKGROUND

Security controllers in contactless applications, such as in a contactless apparatus such as a smartcard, suffer long-term damage if a relatively high voltage is often applied to their antenna contact pins.

However, such a high voltage is used to achieve high communication performance, such as a high signal strength for sending a signal or high reception quality of the signal in the contactless apparatus.

The stress caused by the high voltage in the security controller (or generally in a chip connected to the antenna) must be considered as a parameter when calculating an expected service life.

An example from the prior art relates to a payment transaction using a contactless payment card. Such a payment transaction typically takes less than half a second after introducing the card into a reading area (also referred to as a spatial area in which operation is possible-operating spatial area for short) and has a plurality of transmission phases. Typically, the card is removed from the reading area relatively quickly when the transaction is complete.

However, sometimes a card remains in the reading area for more than half a second. For example, the card is removed only after one or two seconds. In that case, the reading device typically repeatedly performs presence checks which are associated with the high voltages. The high voltage reduces a service life of the (contactless) card.

### SUMMARY

In various exemplary aspects, an apparatus is provided. The apparatus may be a contactless chip apparatus, such as a chip card, or another portable contactless chip apparatus, such as a wearable.

In various exemplary aspects, the apparatus is configured such that the high voltage is provided as the input voltage only when it is actually required by the apparatus. In various exemplary aspects, the apparatus may be configured to first (for example when activating the card, for example by introducing the card into the reading area of an active reading device) provide the high voltage and to reduce the voltage value after an operation has been completed. In various exemplary aspects, the apparatus may be configured to first (for example when activating the card, for example by introducing the card into the reading area of an active reading device) provide a comparatively low voltage which is sufficient, for example, to clarify whether an operation requiring high voltage is provided, and in that case to increase the voltage in a targeted manner. After the operation has been completed, the voltage value can be reduced again.

By limiting the periods in which the input voltage of the apparatus is comparatively high to those periods in which the high input voltage is actually required for operations to be performed, the service life of the (contactless) apparatus is increased.

In various exemplary aspects, the apparatus has at least one processor which is configured to implement the following: performing an operation using energy provided by an external reading device, wherein, when performing the operation, an input voltage of a near-field radio receiver is regulated to a predefined first input voltage value, and, after the operation has been completed, while the near-field radio receiver is still in the electromagnetic field generated by the external reading device, regulating the input voltage of the near-field radio receiver to a second input voltage value lower than the first input voltage value.

In various exemplary aspects, the apparatus may thus be configured to provide the high input voltage at the near-field radio receiver solely for those operations (e.g. providing authentication data, financial transactions, etc.) that require very good (e.g. optimal) signal quality, and, immediately after the operation has been completed, to reduce the input voltage provided at the input of the near-field radio receiver to a value sufficient for basic functions such as a presence check or transmission of an “operation completed” signal.

In various exemplary aspects, an apparatus is provided that has at least one processor which is configured to implement the following: performing an operation using energy provided by an external reading device, wherein, when performing the operation, an input voltage of a near-field radio receiver is regulated to a predefined first input voltage value, and, when a voltage increase criterion has been satisfied, while the near-field radio receiver is still in the electromagnetic field generated by the external reading device, regulating the input voltage of the near-field radio receiver to a second input voltage value higher than the first input voltage value.

Thus, it can be possible to operate the apparatus in principle with a rather more harmless, lower input voltage of the near-field radio receiver, and, only when a relevant operation is provided that requires high, for example optimal, transmission quality, to increase the input voltage of the near-field radio receiver to a value required for this purpose.

### BRIEF DESCRIPTION OF THE DRAWINGS

Exemplary aspects of the disclosure are illustrated in the figures and are explained in more detail below.

In the figures:

FIG. 1A shows an illustration of use of a chip card according to various exemplary aspects;

FIGS. 1B and 1C each show a flowchart for the use of the chip card according to various exemplary aspects;

FIGS. 2A and 2B each show a schematic illustration of an apparatus according to various exemplary aspects;

FIG. 3 shows a schematic illustration of a chip card according to various exemplary aspects; and

FIGS. 4A and 4B each show a flowchart for the use of the apparatus according to various exemplary aspects.

### DETAILED DESCRIPTION

In the detailed description that follows, reference is made to the accompanying drawings, which form part of said description and show, for illustration, specific aspects in which the invention may be performed. In this regard, direction terminology such as, for instance, “at the top”, “at the bottom”, “at the front”, “at the back”, “front”, “rear”, etc. is used with respect to the orientation of the figure(s) described. Since components of aspects may be positioned in a number of different orientations, the directional terminology is used for illustration and is not restrictive in any way. It goes without saying that other aspects may be used and structural or logical changes may be made, without departing from the scope of protection of the present disclosure. It goes without saying that the features of the various exemplary aspects described herein may be combined with one another, unless specifically stated otherwise. The detailed description that follows should therefore not be interpreted in a restrictive sense, and the scope of protection of the present disclosure is defined by the attached claims.

Within the scope of this description, the terms “connected” and “coupled” are used to describe both a direct and an indirect connection and direct or indirect coupling. In the figures, identical or similar elements are provided with identical reference signs if expedient.

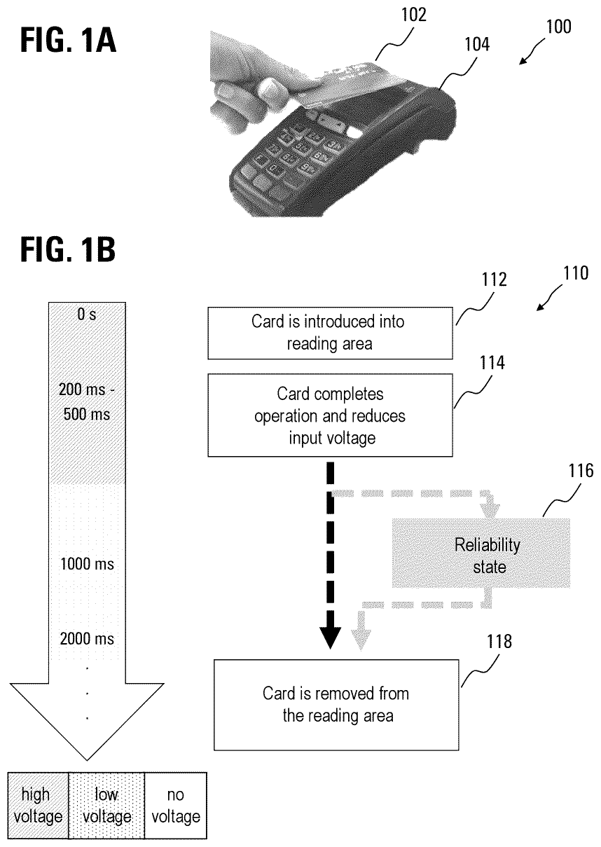

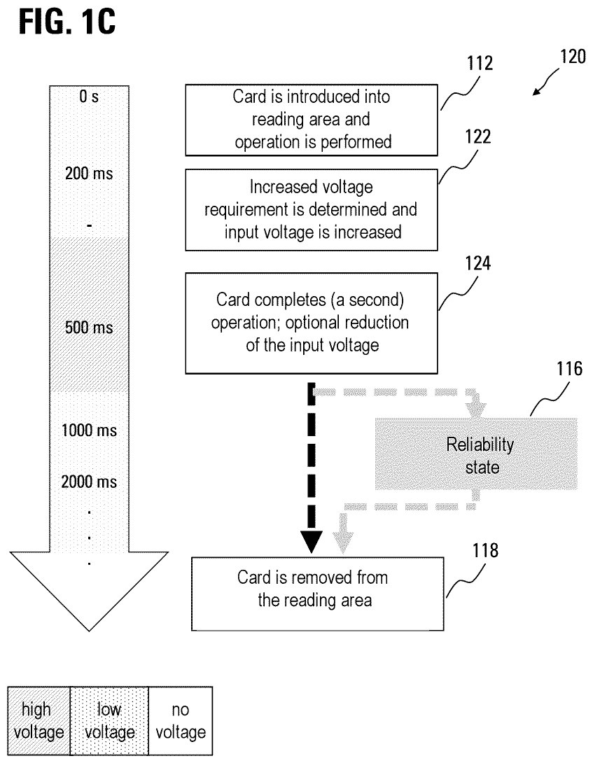

FIG. 1A shows an illustration 100 of use of a chip card 102 according to various exemplary aspects, which comprises an apparatus 200 according to various exemplary aspects.

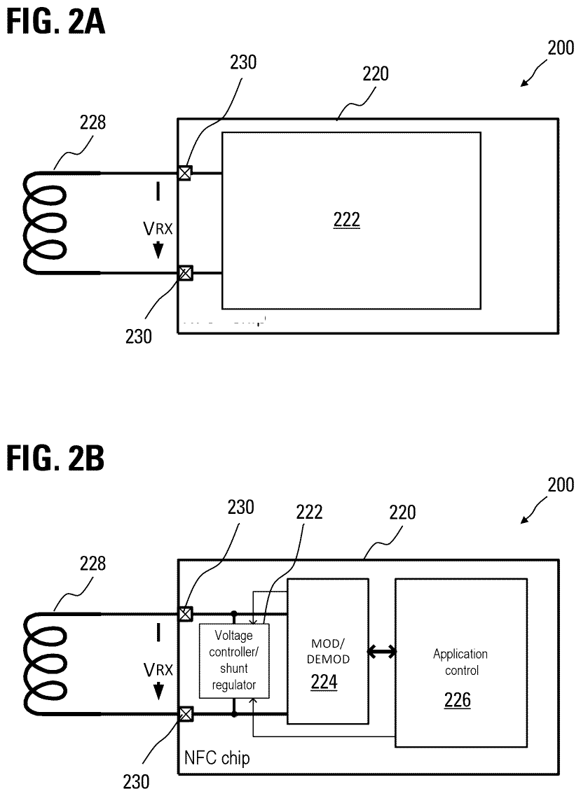

FIGS. 1B and 1C each show a flowchart (110 and 120) for the use of the chip card 102 according to various exemplary aspects, and FIGS. 2A and 2B each show a schematic illustration of an apparatus 200 according to various exemplary aspects.

The apparatus 200 may have at least one processor 222. The processor 222 may be, for example, a microprocessor or have a microprocessor, or another type of suitable processor.

The processor 222 may be designed, for example, as a voltage controller and/or shunt regulator.

The processor 222 can be electrically conductively connected to (two) inputs 230. The inputs 230 can be chip inputs, for example inputs of a chip 220 for providing near-field communication (NFC). Accordingly, the chip can also be referred to as an NFC chip 220.

The apparatus 200 may further comprise a near-field radio receiver 228 which is configured to provide an input voltage V_{RX} at the inputs 230.

FIGS. 2A and 2B illustrate the near-field radio receiver 228 as an antenna. In various exemplary aspects, the near-field radio receiver 228 (for example the antenna) may be configured to interact directly with an external reading device 104 or an electromagnetic field generated by the latter and thereby receive energy which can be provided at the inputs 230.

In various cases, the near-field radio receiver 228 (for example the antenna) may be configured to interact indirectly with the reading device 104 or an electromagnetic field generated by the latter and thereby receive energy which can be provided at the inputs 230. For example, the near-field radio receiver 228 (for example the antenna) may inductively couple to an additional antenna (not shown), for example a booster antenna, which in turn electromagnetically couples to the electromagnetic field provided by the reading device 104.

For communicating with the external reading device, the apparatus may further comprise a modulator/demodulator 224 which may be configured to demodulate the modulated input voltage V_{RX} received at the inputs 230 to form a data signal, and vice versa to modulate a data signal to be transmitted onto the input voltage.

The apparatus 200 may further comprise additional components, for example a second processor 226 or (micro) controller for application control.

In the case of security-relevant applications, for example, payment transactions and/or authentication processes, the second processor 226 may be, for example, a so-called security processor configured for cryptographic methods.

In various exemplary aspects, the processor 222, the second processor 226 and/or the modulator/demodulator 224 may be formed as separate elements, in an integrated manner, or jointly as a system-on-chip (the system-on-chip is schematically illustrated in FIG. 2B, wherein the processor 222, the second processor 226 and the modulator/demodulator 224 are connected to each other; corresponding connections are also present in a design as separate elements—e.g. on separate chips).

In various exemplary aspects, the processor 222 may be configured to implement performance of an operation using energy provided by an external reading device 104 (e.g. in the form of an electromagnetic field, for example in accordance with standards for near-field communication), wherein, when performing the operation, an input voltage V_{RX} of the near-field radio receiver 228 is regulated to a predefined first input voltage value.

If the processor 222 and the second processor 226 are not formed in an integrated manner, implementing performance may be understood as meaning that the processor 222 makes it possible for the operation to be performed by the second processor 226 or assists with this.

If the processor 222 and the second processor 226 are formed in an integrated manner, for example by the voltage regulation and the performance of the operations being performed by a single processor 222, 226, implementing performance can be understood as meaning performance.

The operation may be, for example, an operation typically provided by means of near-field communication, for example a financial transaction (such as a payment process) and/or authentication.

For example, the operation may require a comparatively high input voltage V_{RX} to ensure high signal quality.

The operation can be performed in various cases using the second processor 226.

The processor 222 may also be configured, after the operation has been completed, while the near-field radio receiver is still in the electromagnetic field generated by the external reading device, to regulate the input voltage V_{RX} of the near-field radio receiver 228 to a second input voltage value lower than the first input voltage value.

The completion of the operation can be indicated to the processor 222, for example, by means of the second processor 226.

The processor 222 may be configured to regulate the input voltage V_{RX} to the second (lower) input voltage value substantially immediately after the operation has been completed, for example substantially immediately after receiving the information that the operation has been completed. For example, a typical duration for performing an operation can be in a range from 100 ms to approximately 5 s.

In particular, operations with a long total duration may possibly have multiple sub-operations that allow the input voltage to additionally be reduced to the second input voltage value between the performance of the individual sub-operations.

Regulation can comprise, for example, controlling a shunt which, depending on the control, dissipates or does not dissipate a predetermined amount of excess energy.

FIG. 1B illustrates the procedure described above: When the apparatus 200 (in this case as part of a chip card 102) is introduced into a reading area of the external reading device, the input voltage is initially provided with the higher, first input voltage value (for example in a range from approximately 4 V to approximately 5 V, for example in a range from approximately 4.2 V to approximately 4.8 V, for example approximately 4.5 V), the operation is completed and the input voltage is then reduced to the second, lower input voltage value (for example in a range from approximately 3 V to less than 4 V, for example in a range from approximately 3.2 V to approximately 3.8 V, for example approximately 3.5 V).

The time arrow on the left-hand side shows, using hatching, the time period in which the input voltage has the high, first value, and shows, using dots, the time period in which the input voltage has the lower, second value (also referred to as “reliability state”).

After removing the chip card 102 (and thus the apparatus 200) from the reading area, the input voltage falls to zero volts.

In various exemplary aspects, an apparatus 200 is provided that corresponds, in terms of design, to the apparatus 200 described above.

Its processor may be configured to implement performance of a (first) operation using energy provided by the external reading device 104, wherein, when performing the operation, an input voltage of a near-field radio receiver 228 is regulated to a predefined first input voltage value.

Unlike the case described above, the (first) operation may be designed such that it does not require a high input voltage value.

For example, the first operation may involve charging an energy storage device inside the apparatus, and/or determining which operation is intended to be next.

In other words, in various exemplary aspects, the input voltage can first be provided with a low input voltage value sufficient for basic applications.

The processor 222 may also be configured, if a voltage increase criterion has been satisfied, while the near-field radio receiver 228 is still in the electromagnetic field generated by the external reading device 104, to implement regulation of the input voltage of the near-field radio receiver 228 to a second input voltage value higher than the first input voltage value.

This means that the input voltage is increased only when there is a need for a higher input voltage, which can be indicated, for example, to the processor 222 by means of the second processor 226.

A corresponding illustration is shown in FIG. 1C: When the apparatus 200 (again as part of a chip card 102) is introduced into a reading area of the external reading device 104, the input voltage is first provided with the lower, first input voltage value (for example in a range from approximately 3 V to less than 4 V, for example in a range from approximately 3.2 V to approximately 3.8 V, for example approximately 3.5 V) and a (first) operation is performed. After determining that an increased input voltage is required, the input voltage is increased to the second, higher input voltage value (for example in a range from approximately 4 V to approximately 5 V, for example in a range from approximately 4.2 V to approximately 4.8 V, for example approximately 4.5 V).

After increasing the input voltage, it is possible to perform a second operation that can correspond, for example, to the operation explained above in connection with FIG. 1B.

In various exemplary aspects, after the second operation has been completed, the input voltage can be reduced again, similar to the procedure explained in connection with FIG. 1B.

After removing the chip card 102 (and thus the apparatus 200) from the reading area, the input voltage falls to zero volts.

The time arrow on the left-hand side shows, using hatching, the time period in which the input voltage has the high, second value, and shows, using dots, the time period in which the input voltage has the lower, first value.

In various exemplary aspects, the processor may also be configured to detect an additional state of the apparatus, to compare the detected additional state with an additional voltage adjustment criterion, and, if the additional voltage adjustment criterion has been satisfied, to adjust the input voltage.

The additional state may be, for example, a current service life of the apparatus, which may still be below or equal to or above a maximum value for a tolerable service life, a temperature of the apparatus 200, for example of the processor 222, which should not exceed a maximum temperature, and/or a number of unsuccessful attempts to perform the operation, in the case of which it may not be useful to exceed a maximum number.

The apparatus 200 may have corresponding sensors and/or memories, for example one or more temperature sensors for measuring the temperature, memories for storing a service life counter and/or for adding up unsuccessful attempts when performing the operation, or similar functions which can benefit from reducing the input voltage V_{RX}.

In the examples of the additional state mentioned above, adjusting the input voltage may accordingly comprise reducing the input voltage.

In various exemplary aspects, the additional state may comprise detecting faulty communication.

This may mean that the input voltage provided may not be high enough to provide sufficient signal quality.

Accordingly, adjusting the input voltage may comprise increasing the input voltage.

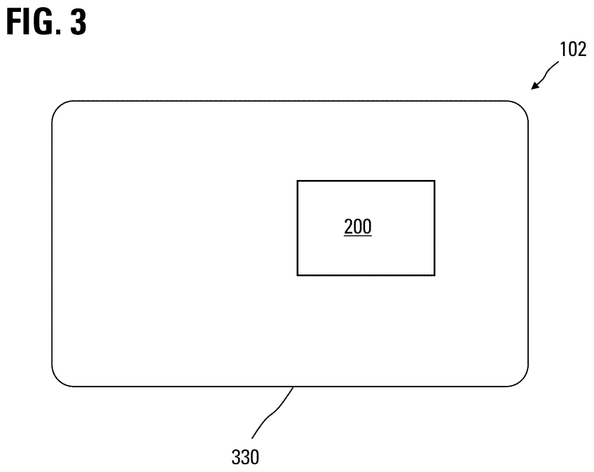

FIG. 3 shows a schematic illustration of a smart chip card 102 according to various exemplary aspects.

The chip card 102 may be an apparatus 200 according to various exemplary aspects, for example as described above, for example in connection with FIGS. 1A to 2B.

The chip card 102 may further comprise a chip card body 330. The apparatus 200 may be arranged in or on the chip card body 330, for example embedded in the chip card body 330.

In various exemplary aspects, the near-field radio receiver 228 may surround a large area portion of the chip card body, for example may run as an antenna along an edge of the chip card body 330, while the processor can cover a comparatively small surface area of the chip card body 330.

In various exemplary aspects, the near-field radio receiver 228 of the apparatus 200 may also cover a small surface area, for example may be arranged together with the chip 220 on a chip module. Optionally, a booster antenna can be arranged in the chip card body 330, to which the near-field radio receiver 228 can couple for indirect coupling to the external reading device 104.

It should be understood that the chip card 102 is representative of a multiplicity of possible devices which may comprise the apparatus, for example other wearables such as smartwatches, smart rings or the like.

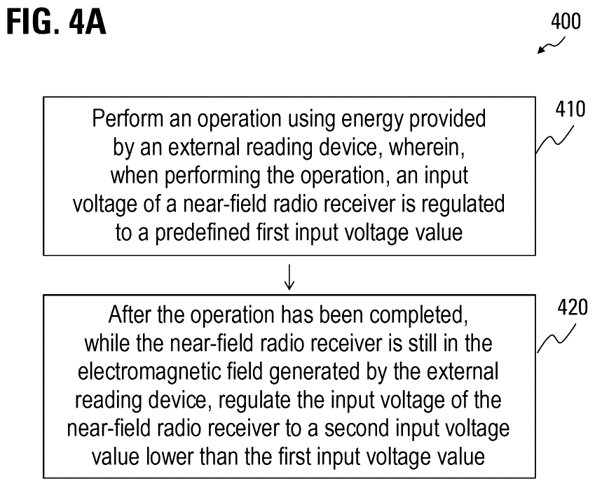

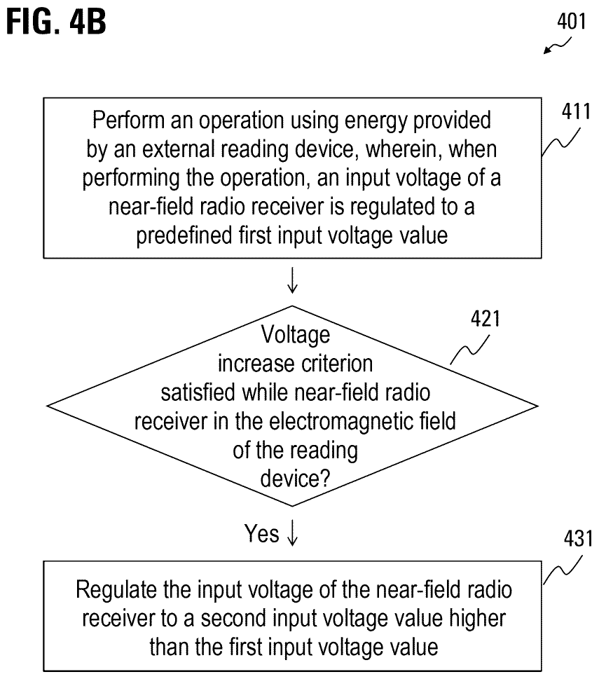

FIG. 4A shows a flowchart 400 for the use of the apparatus according to various exemplary aspects, for example an apparatus 200 as described above.

The method comprises performing an operation using energy provided by an external reading device, wherein, when performing the operation, an input voltage of a near-field radio receiver is regulated to a predefined first input voltage value (410), and, after the operation has been completed, while the near-field radio receiver is still in the electromagnetic field generated by the external reading device, regulating the input voltage of the near-field radio receiver to a second input voltage value lower than the first input voltage value (420).

FIG. 4B shows a flowchart 400 for the use of the apparatus according to various exemplary aspects, for example an apparatus 200 as described above.

The method comprises performing an operation using energy provided by an external reading device, wherein, when performing the operation, an input voltage of a near-field radio receiver is regulated to a predefined first input voltage value (411), determining whether a voltage increase criterion has been satisfied, while the near-field radio receiver is in an electromagnetic field of the reading device (421), and, if so, regulating the input voltage of the near-field radio receiver to a second input voltage value higher than the first input voltage value (431).

Some exemplary aspects are specified in summary below.

Exemplary aspect 1 is an apparatus comprising at least one processor which is configured to implement the following: performing an operation using energy provided by an external reading device, wherein, when performing the operation, an input voltage of a near-field radio receiver is regulated to a predefined first input voltage value, and, after the operation has been completed, while the near-field radio receiver is still in the electromagnetic field generated by the external reading device, regulating the input voltage of the near-field radio receiver to a second input voltage value lower than the first input voltage value.

Exemplary aspect 2 is an apparatus according to exemplary aspect 1, wherein the operation comprises a financial transaction and/or authentication.

Exemplary aspect 3 is an apparatus according to exemplary aspect 1 or 2, wherein the operation comprises a plurality of sub-operations, wherein the processor is also configured to regulate the input voltage of the near-field radio receiver to the second input voltage value between each of the plurality of sub-operations, and, for each of the plurality of sub-operations, to regulate the input voltage of the near-field radio receiver to the first input voltage value.

Exemplary aspect 4 is an apparatus comprising at least one processor which is configured to implement the following: performing an operation using energy provided by an external reading device, wherein, when performing the operation, an input voltage of a near-field radio receiver is regulated to a predefined first input voltage value, and, if a voltage increase criterion has been satisfied, while the near-field radio receiver is still in the electromagnetic field generated by the external reading device, regulating the input voltage of the near-field radio receiver to a second input voltage value higher than the first input voltage value.

Exemplary aspect 5 is an apparatus according to exemplary aspect 4 which is also configured to perform a second operation using energy provided by the external reading device with the second input voltage value.

Exemplary aspect 6 is an apparatus according to exemplary aspect 5 which also comprises, after the second operation has been completed, while the near-field radio receiver is still in the electromagnetic field generated by the external reading device, regulating the input voltage of the near-field radio receiver to the first input voltage value.

Exemplary aspect 7 is an apparatus according to exemplary aspect 5 or 6, wherein the second operation comprises a financial transaction and/or authentication.

Exemplary aspect 8 is an apparatus according to one of exemplary aspects 5 to 7, wherein the second operation comprises a plurality of sub-operations, wherein the processor is also configured to regulate the input voltage of the near-field radio receiver to the second input voltage value between each of the plurality of sub-operations, and, for each of the plurality of sub-operations, to regulate the input voltage of the near-field radio receiver to the first input voltage value.

Exemplary aspect 9 is an apparatus according to one of exemplary aspects 1 to 8 which further comprises a shunt, wherein the processor is configured to regulate the input voltage of the near-field radio receiver by controlling the shunt.

Exemplary aspect 10 is an apparatus according to one of exemplary aspects 1 to 9, wherein the processor is also configured to detect an additional state of the apparatus, to compare the detected additional state with an additional voltage adjustment criterion, and, if the additional voltage adjustment criterion has been satisfied, to adjust the input voltage.

Exemplary aspect 11 is an apparatus according to exemplary aspect 10, wherein the additional state comprises a state from a group of states, the group comprising or consisting of a current service life of the apparatus, a temperature of the apparatus, and a number of unsuccessful attempts to perform the operation.

Exemplary aspect 12 is an apparatus according to exemplary aspect 10 or 11, wherein the adjustment of the input voltage comprises reducing the input voltage.

Exemplary aspect 13 is an apparatus according to exemplary aspect 10, wherein the additional state comprises detecting faulty communication.

Exemplary aspect 14 is an apparatus according to exemplary aspect 10 or 13, wherein the adjustment of the input voltage comprises increasing the input voltage.

Exemplary aspect 15 is an apparatus according to one of exemplary aspects 1 to 14, wherein the near-field radio receiver has an antenna which is electrically conductively connected to inputs for providing the input voltage and is configured to electromagnetically couple directly or indirectly to the external reading device.

Exemplary aspect 16 is a chip card comprising a chip card body and an apparatus according to one of exemplary aspects 1 to 15.

Exemplary aspect 17 is a method for operating an apparatus. The method comprises performing an operation using energy provided by an external reading device, wherein, when performing the operation, an input voltage of a near-field radio receiver is regulated to a predefined first input voltage value, and, after the operation has been completed, while the near-field radio receiver is still in the electromagnetic field generated by the external reading device, regulating the input voltage of the near-field radio receiver to a second input voltage value lower than the first input voltage value.

Exemplary aspect 18 is a method for operating an apparatus. The method comprises performing an operation using energy provided by an external reading device, wherein, when performing the operation, an input voltage of a near-field radio receiver is regulated to a predefined first input voltage value, and, if a voltage increase criterion has been satisfied, while the near-field radio receiver is still in the electromagnetic field generated by the external reading device, regulating the input voltage of the near-field radio receiver to a second input voltage value higher than the first input voltage value.

Further advantageous configurations of the apparatus are evident from the description of the method, and vice versa.

1. An apparatus, comprising:
at least one processor configured to:
perform an operation using energy provided by an external reading device, wherein, when performing the operation, an input voltage of a near-field radio receiver is regulated to a predefined first input voltage value; and
after the operation has been completed, while the near-field radio receiver is still in an electromagnetic field generated by the external reading device, regulate the input voltage of the near-field radio receiver to a second input voltage value lower than the first input voltage value.

2. The apparatus as claimed in claim 1, wherein the operation comprises a financial transaction and/or authentication.

3. The apparatus as claimed in claim 1,
wherein the operation has a plurality of sub-operations; and
wherein the at least one processor is also configured to regulate the input voltage of the near-field radio receiver to the second input voltage value between each of the plurality of sub-operations and, for each of the plurality of sub-operations, to regulate the input voltage of the near-field radio receiver to the first input voltage value.

4. An apparatus, comprising:
at least one processor which is configured to:
perform an operation using energy provided by an external reading device, wherein, when performing the operation, an input voltage of a near-field radio receiver is regulated to a predefined first input voltage value; and
if a voltage increase criterion has been satisfied, while the near-field radio receiver is still in an electromagnetic field generated by the external reading device, regulate the input voltage of the near-field radio receiver to a second input voltage value higher than the first input voltage value.

5. The apparatus as claimed in claim 4, wherein the at least one processor is further configured to:
perform a second operation using energy provided by the external reading device with the second input voltage value.

6. The apparatus as claimed in claim 5, wherein the at least one processor is further configured to:
after the second operation has been completed, while the near-field radio receiver is still in the electromagnetic field generated by the external reading device, regulate the input voltage of the near-field radio receiver to the first input voltage value.

7. The apparatus as claimed in claim 5, wherein the second operation comprises a financial transaction and/or authentication.

8. The apparatus as claimed in claim 5,
wherein the second operation has a plurality of sub-operations; and
wherein the a least one processor is also configured to regulate the input voltage of the near-field radio receiver to the second input voltage value between each of the plurality of sub-operations and, for each of the plurality of sub-operations, to regulate the input voltage of the near-field radio receiver to the first input voltage value.

9. The apparatus as claimed in claim 1, further comprising:
a shunt,
wherein the at least one processor is configured to regulate the input voltage of the near-field radio receiver by controlling the shunt.

10. The apparatus as claimed in claim 1, wherein the at least one processor is also configured:
to detect an additional state of the apparatus;
to compare the detected additional state with an additional voltage adjustment criterion; and
if the additional voltage adjustment criterion has been satisfied, to adjust the input voltage.

11. The apparatus as claimed in claim 10, wherein the additional state comprises a state from a group of states comprising or consisting of:
a current service life of the apparatus;
a temperature of the apparatus; and
a number of unsuccessful attempts to perform the operation.

12. The apparatus as claimed in claim 10, wherein adjusting the input voltage comprises reducing the input voltage.

13. The apparatus as claimed in claim 10, wherein the additional state comprises detecting faulty communication.

14. The apparatus as claimed in claim 10, wherein adjusting the input voltage comprises increasing the input voltage.

15. The apparatus as claimed in claim 1, wherein the near-field radio receiver comprises an antenna which is electrically conductively connected to inputs for providing the input voltage and is configured to electromagnetically couple directly or indirectly to the external reading device.

16. A chip card, comprising:
a chip card body; and
an apparatus as claimed in claim 1.

17. A method for operating an apparatus, the method comprising:
performing an operation using energy provided by an external reading device, wherein, when performing the operation, an input voltage of a near-field radio receiver is regulated to a predefined first input voltage value; and
after the operation has been completed, while the near-field radio receiver is still in an electromagnetic field generated by the external reading device, regulating the input voltage of the near-field radio receiver to a second input voltage value lower than the first input voltage value.

18. A method for operating an apparatus, the method comprising:
performing an operation using energy provided by an external reading device, wherein, when performing the operation, an input voltage of a near-field radio receiver is regulated to a predefined first input voltage value; and
if a voltage increase criterion has been satisfied, while the near-field radio receiver is still in an electromagnetic field generated by the external reading device, regulating the input voltage of the near-field radio receiver to a second input voltage value higher than the first input voltage value.
